(19) United States
(12) Patent Application Publication
(10) Pub. No.: US 2005/0095969 A1
(43) Pub. Date: May 5, 2005

(54) Method and apparatus for the euthanasia of animals

(76) Inventor: Howard E. Mosher, Killingworth, CT (US)

Correspondence Address: STEPHEN B. DAVIS;BRISTOL-MYERS SQUIBB COMPANY, PATENT DEPARTMENT, P O BOX 4000, PRINCETON, NJ, 08543-4000, US

(21) Appl. No.: 10/957,789

(22) Filed: Oct. 4, 2004

Related U.S. Application Data
(60) Provisional application No. 60/510,280, filed on Oct. 10, 2003.

(51) Int. Cl. A22B 7/00

(52) U.S. Cl. 452/52

(57) ABSTRACT

A method and apparatus for the humane euthanasia of small animals, particularly rodents, involves the use of a programmable controller and animal holding chamber. The device consists of a Mass Flow Controller (“MFC”) with a closed loop interfacing with the use of a Programmable Logic Controller (“PLC”) to provide a constant flow rate of gas under a specific pressure for a specified time. The PLC is preprogrammed to provide various cycles that are designed to provide the proper flow rate for each animal species. The program allows for a two-stage flow rate cycle so that in the first stage the animal is anesthetized from the upright to unconscious position and in the second stage the animals are euthanatized as measured by the cessation of respiration and heartbeat. This two-stage euthanasia system reduces the amount of distress the animals experience during the process. Additionally, standardizing and programming the equipment used for the euthanasia process will ensure the system is used correctly and higher standards for compliance consistently met.

### CROSS REFERENCE TO RELATED APPLICATION

This non-provisional application claims priority from provisional application U.S. Ser. No. 60/510,280 filed Oct. 10, 2003.

### FIELD OF THE INVENTION

This invention relates to a method and apparatus for the euthanasia of animals, particularly rodents. The invention involves a gaseous euthanasia apparatus comprising a programmable controller and chamber.

### BACKGROUND OF THE INVENTION

It is commonly accepted that euthanasia of animals should be conducted effectively in a painless manner and without causing excessive excitation of the animal. Various methods of euthanasia have been described in the literature. The methods include mechanical and electrical means as well as inhalation of gases and administration of anesthetic fluids. For example, see Vet. Rec. 116, 416 (1985) and Comp. Med. 53(3) 249-257 (2002).

Gas inhalation has been endorsed as the most efficient way of euthanitizing large numbers of small animals, including but not limited to rodents, such as mice, rats, guinea pigs, and others. Carbon dioxide is the most widely used gas for euthanasia of rodents and is on the list of acceptable agents recommended by the American Veterinary Medical Association (AVMA) as described in J. Am. Vet. Med. 202(2): 229-249 (1996).

Despite the fact that carbon dioxide is widely used for rodent euthanasia, questions have arisen regarding its use for humane euthanasia because of alleged concerns that asphyxiation or hypoxia may precede anesthesia as described in Lab. Anim. 223:220-228 (1989). According to the AVMA, the suitability of a method or apparatus for euthanasia depends on whether an animal experiences distress between the time it begins to inhale the euthanisizing agent and the time it loses consciousness.

Distress is an aversive state in which the animal is unable to adapt to stressors and the resulting distress presents as maladaptive behaviors exemplified but not limited to struggling, attempts to escape, salivation, urination and reflex muscle contractions such as tremors, shivers and spasms.

Based on the foregoing, it is an objective of the present invention to provide a method of and apparatus for gaseous euthanasia of small animals which is humane, painless and does not induce fear or apprehension in the animal. It is a further objective that the method and apparatus be reliable, cost-effective, provide a high standard of compliance for the operator, and be safe and easy to operate. The device of the present invention advantageously minimizes operator input as to gas flow rates and times and actual handling of the animals themselves resulting in the reduction of operational and compliance issues.

### SUMMARY OF THE INVENTION

The present invention is an apparatus comprising at least two parts: an euthanitizing gas controller and an animal holding chamber used to euthanitize small animals through the use of an automated programmable device specific to the animal to be euthanatized. The gas controller includes of a Mass Flow Controller (“MFC”) with the use of a Programmable Logic Controller (“PLC”) to provide a constant flow rate of gas under a specific pressure for a specified time. The PLC is preprogrammed to provide various cycles, which are designed to provide the proper flow rates for each animal species. One type of animal is a rodent.

The apparatus for the humane euthanasia of animals has a controller and an animal holding chamber or euthanitizing chamber connected by hoses leading to and from each unit and positioned to be capable of uniformly distributing one or more euthanisizing gases to the controller or chamber. An euthanitizing gas is carbon dioxide.

The controller has a Programmable Logic Controller (“PLC”) that is a programmable electronic controlling device and timer that interfaces with a Mass Flow Controller (“MFC”) and with a closed loop controller to furnish a range of gas flow rate and timer cycles that provide a proper and consistent flow rate of euthanitizing gas under specific pressure and for a specific time for the specific species of animal to be euthanatized. The controller also includes a gas supply port that functions by using a valve that directly interfaces with the PLC and MFC to furnish the proper gas flow rate in a consistent manner from the controller to the chamber. Additionally, the controller has a purge valve that interfaces with the PLC to accept gases evacuated from the chamber after the cycle is completed and a pressure relief valve that is directly connected to the purge valve to evacuate any gas pressure that has been exceeded in the chamber. Lastly, an alarm light (4) that directly interfaces with the PLC informs the operator of the apparatus of any malfunctions.

The euthanitizing chamber has a removable sliding lid incorporating an electronic locking latch having a sensor that interfaces with the PLC and signals that the chamber is ready to be charged or purged at the end of each operating cycle.

The chamber also has tubing for accepting one or more gases entering the chamber from the controller, whereby the tubing is positioned in the chamber at the appropriate height to eliminate gas blowing down on the animals and to provide optimal mixing of the gases. The chamber further has an exhaust port connected to the controller for evacuating gases that is positioned to allow rapid evacuation of all the gas within the chamber during the purge cycle and wherein the purged gas is vacuumed directly into a house vacuum system minimizing any exposure to the operator of the system.

The present invention further comprises a method for the humane euthanasia of small animal species comprising an apparatus having a programmable standardized controller connected via suitable tubing to an animal holding chamber. The controller uses a Mass Flow Controller (“MFC”) with a closed loop controller that interfaces with a Programmable Logic Controller (“PLC”) to provide a constant flow rate of euthanisizing gases under a specific pressure for a specific time. Due to the automation and preprogrammed cycles, the proper gas flow rate is delivered that is suitable for the specific species to be euthanatized. Operator contact for animal handling and gas flow and timer cycles is minimized resulting in a higher standard of uniformity and compliance.

### BRIEF DESCRIPTION OF THE DRAWINGS

FIG. 1 is a front view of the apparatus of the present invention.

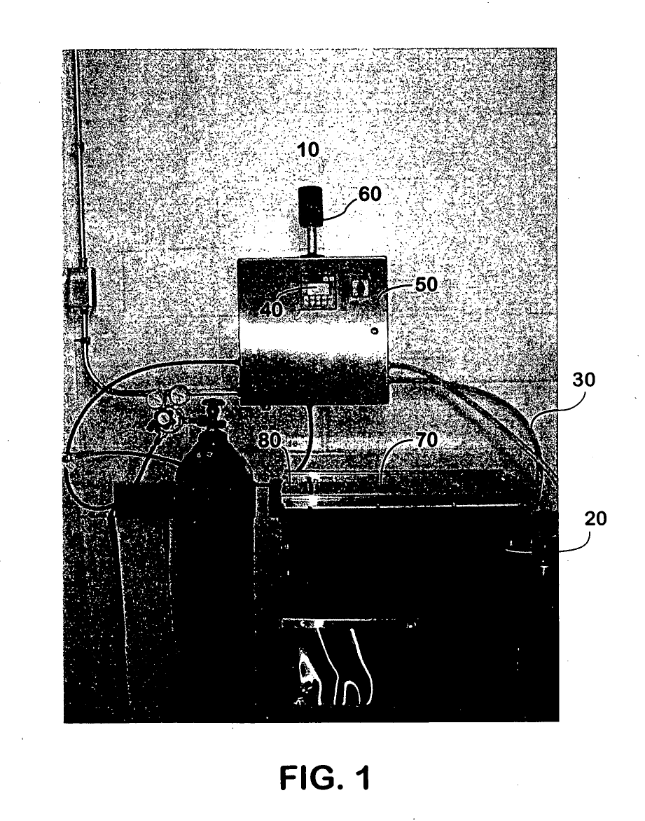

FIG. 2 is an interior view of the programmable controller.

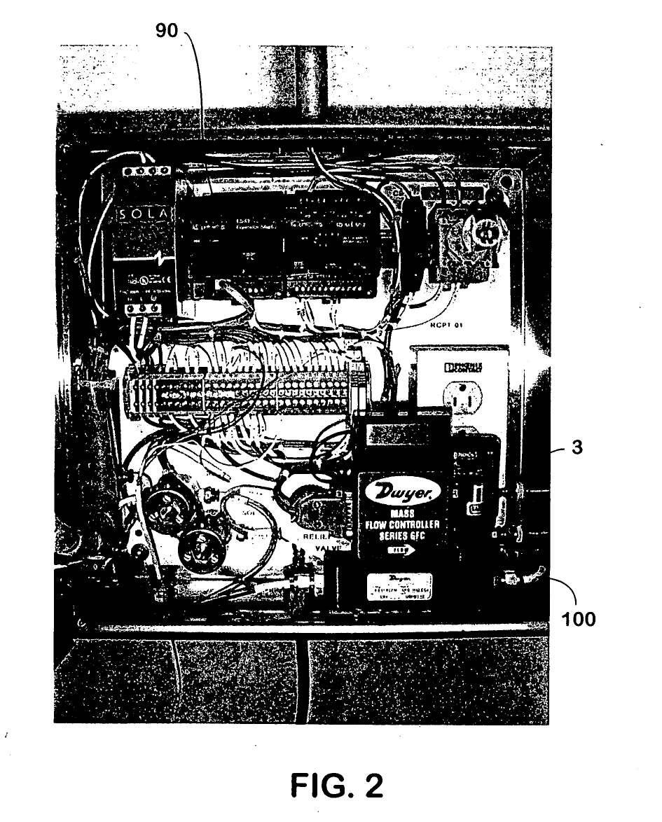

### DETAILED DESCRIPTION OF THE INVENTION

Small animal, particularly rodent, euthanasia is commonly performed by placing the animals in a chamber that is connected to a carbon dioxide tank and allowing the gas to flow until the animals are euthanatized as measured by cessation of heartbeat and respiration. Due to lack of automation and operator error this process lacks standardization and compliance with the Animal Welfare Act. Despite the widespread use of carbon dioxide in the euthanasia of laboratory animal species, considerable controversy exists concerning whether distress is associated with carbon dioxide induction, as studies have produced contradictory results as to whether a high level of distress was experienced by rodents prior to loss of consciousness. Another area of controversy is whether the stress level of the animal is increased if the chamber is pre-filled or post-filled with gas before the process is initiated.

The apparatus 10 that has an animal holding chamber or euthanitizing chamber 20 that is post-charged with gas since our data show this method created less discomfort for the animal during the euthanasia process. The apparatus 10 and method is developed to be automated and to eliminate as much interaction by personnel as possible. The use of a Programmable Logic Controller (PLC) and Mass Flow Controller 90 provides unlimited control and accuracy when dispensing the gas into the chamber. The PLC has a graphical screen 40 and provides a display to inform the personnel using the equipment of the various stages during the process. Access for program changes is password protected so that when the system is setup, only authorized personnel can make changes. The following will describe the design of the system and discuss the procedure that is followed when operating the system.

Controller Design

In accordance with one aspect of the invention, there is provided an apparatus and method using a Mass Flow Controller (MFC) with the use of a Programmable Logic Controller (PLC) to provide a constant flow rate of gas under a specific pressure for a specified time. One type of gas is carbon dioxide.

The PLC can be programmed to provide various cycles, which are designed to provide the proper flow rate for each animal species. In one embodiment of the invention, the animal is a rodent. In another aspect of the invention, the program allows for a two-stage flow rate cycle. In this cycle the animal progresses from the upright to unconscious state during the first low gas flow phase of the cycle and then to the terminal stage during the second increased flow stage. This programming reduces the distress felt by the animal by allowing it to be anesthetized prior to the terminal stage.

The graphical screen 40 for the system is designed to be simple for personnel to operate properly. It allows the ability to adjust flow rates and timer functions to accommodate various sizes of chambers and different species of animals. It has been designed to accommodate both carbon dioxide (CO₂) and other gases such as argon blends or carbon dioxide:oxygen mixtures.

In one example, the enclosure for the controller 50 is a moisture-proof NEMA 4 cabinet constructed of stainless steel and in one embodiment is mounted to the wall. The lid is 70 secured to prevent tampering with the internal control systems. This setting is merely exemplary and should not be considered as limiting in any way.

The primary component of this control system is a programmable electronic controlling device and timer defined as a Programmable Logic Controller (PLC) with a graphical display 40 The electronic controlling device is readily available through various manufacturers and is programmable for specific uses. This display provides written instructions to inform the operator of each step in the process. This display also monitors and checks each stage of the process and will alarm the operator if there is any malfunction. The PLC provides all the timer and flow rate functions for this process. The PLC allows the system to have multiple phases that provide variable flow rates and exposure times for each species.

The CO₂ gas is controlled by a Mass Flow Controller 90 that maintains the proper flow rate, a closed loop controller that maintains a constant flow rate, and a solenoid valve which closes the gas supply line when the PLC determines the rate has been exceeded.

A purge valve 100 was installed to evacuate the gas after the operation is completed to allow an empty chamber prior to its next use. This operation also includes a pressure relief valve to prevent over pressurizing the chamber.

There is a red light 60 on the top of controller that notifies the operator of any malfunctions and when the CO₂ tank is empty. The PLC provides a graphical text message 40 to the operator with details of the malfunction.

Chamber Design

The holding chamber 20 for the animals was designed to accommodate both a gas supply port located so that the animals cannot feel the gas flow and an exhaust port to evacuate all gases before loading the next group of animals. The chamber has an electronically controlled locking latch 80 to ensure that the chamber cannot be opened during operation.

For purposes of demonstration, two sizes of chambers 20 were constructed. The smaller size chamber (approximately 0.75 cubic feet) is capable of handling 1-3 rats while the larger chamber (approximately 2.5 cubic feet) is designed to handle larger groups of rats. A large rodent cage may be placed inside the large chamber, which helps to reduce the stress to the animal. Although particular reference has been made above to the size if the chambers and the euthanasia of rats, the same technique using the same method and apparatus can be used for the euthanasia of a variety of other small animals, including but not limited to mice, gerbils, guinea pigs and others in various chamber sizes.

The chambers are constructed of materials to allow for easy sanitation. Examples include but are not limited to acrylic and polycarbonate.

In one embodiment, black acrylic makes up three sides of the chamber to obstruct viewing for both animals and individuals not involved in the euthanasia process. The top and front of the chamber is made from clear polycarbonate to allow adequate visibility for the person performing the euthanasia process.

The lid 70 slides so that it is easily removed for proper sanitizing. The lid incorporates an electronic locking latch 80 with a sensor to signal the Programmable Logic Controller (PLC) that the chamber is ready to be charged or purged at the end of the cycle.

The gas enters the chamber from the side into the upper three-quarters of the chamber to provide a better mixing of the gas and to eliminate the gas from blowing directly onto the animals.

An exhaust port approximately one inch from the floor, runs the width of the side to allow for rapid evacuation of the gas within the chamber during the purge cycle. The gas is evacuated directly into the house vacuum system to minimize any exposure to the operator.

In one embodiment, all hose connections are ⅝″ OD and have ⅜″ ID braided chemical grade hoses. These hoses allow a more consistent gas flow and minimize the possibility of the gas freezing the lines during the process.

In another embodiment of the invention, an electronic switch panel was designed that accommodates larger groups of animals by utilizing two chambers in sequence, The use of this switch panel in conjunction with the controller reduced the time of exposure to less than half the previous method.

Euthanasia Chamber Operation

This example is designed for small animals (rodents). It is necessary for the operator to select the appropriate species cycle when performing this procedure.

The cycles are designed to provide the proper flow rate to allow the animal to progress from the upright to the unconscious stage and then increase the flow rate to the terminal stage.

This system was designed to have the chamber filled with gas only after the animals have been placed into the chamber (post-filled chamber).

The system operates at 20 lbs. of CO₂ gas supply. When changing the CO₂ tank personnel must ensure the pressure gauge reads 20 psi. The following are directions for personnel who use the system:
1. Place an absorbable liner in bottom of chamber (if using the large chamber, the cage may be placed directly into the chamber).
2. Place animals in the empty chamber.
3. Slide lid to close it tightly
4. Press “Start” button on controller (lid will lock)
5. Select proper cycle for the species (gas will start to flow)
6. (1) Mice
7. (2) Rats
8. (3) Guinea Pig
9. (4) Other
10. When the cycle is completed slide the lid open, observe animals and verify the lack of respiration and a heartbeat on each animal.
11. If additional exposure is required, slide the lid closed and press the left arrow button on controller to provide one minute of additional gas flow. This step can be repeated an unlimited number of times.
12. If there is no sign of respiration and no heartbeat, remove animals from the chamber and place them in the appropriate container.
13. Press “enter” on the controller to purge chamber (lid must be open).
14. Remove soiled liners or the cage and sanitize chamber with the appropriate agent.
15. In another embodiment for larger groups of animals it is possible to design a device that will allow one CO₂ controller to operate two chambers sequentially. This allows the second chamber to be used while the first is being cleaned.

In a further embodiment of the present invention, it is possible to design a mobile unit that will have the same type of controller, a large chamber and a vacuum pump.

This system has eliminated the issue of how much carbon dioxide should be administered to various animal species and how long the exposure time should be. This system has been readily acceptable by staff members and increased compliance.

Although the present invention has been described in considerable detail with reference to certain preferred versions thereof, other versions are possible. Therefore the spirit and scope of the appended claims should not be limited to the description of the preferred versions contained herein.

1. An apparatus for the humane euthanasia of animals comprising a controller comprising a Programmable Logic Controller (“PLC”) having a programmable electronic controlling device and timer that interfaces with a Mass Flow Controller (“MFC”) and with a closed loop controller to furnish a range of gas flow rate and timer cycles that provide a proper and consistent flow rate of euthanitizing gas under specific pressure and for a specific time for the animal to be euthanatized and a means for supplying one or more gases from the controller that directly interfaces with the PLC and MFC to furnish the proper gas flow rate; and an euthanitizing chamber incorporating an electronic locking latch having a sensor that interfaces with the PLC and signals that the chamber is ready to be charged or purged at the end of the cycle and a means for accepting one or more gases entering the chamber from the controller.

2. A method for the humane euthanasia of small animal species comprises an apparatus comprising a programmable standardized controller connected via suitable tubing to an animal holding chamber, wherein the controller uses a Mass Flow Controller (“MFC”) with a closed loop controller interfacing with a Programmable Logic Controller (“PLC”) to provide a constant flow rate of euthanisizing gases under a specific pressure for a specific time.
